(19) United States
(12) Patent Application Publication
(10) Pub. No.: US 2016/0330944 A1
(43) Pub. Date: Nov. 17, 2016

(54) Dive Hook

(71) Applicant: Matthew C. Miller, Live Oak, FL (US)

(72) Inventor: Matthew C. Miller, Live Oak, FL (US)

(21) Appl. No.: 14/713,757

(22) Filed: May 15, 2015

(51) Int. Cl. A01K 83/00; A01K 97/00; A01K 91/06

(52) U.S. Cl. CPC A01K 83/00; A01K 91/06; A01K 97/00

(57) ABSTRACT

Embodiments of the invention provide fishing hook assemblies for attachment to a fishing line for movement through water. In one embodiment the assembly comprises a head region, wherein the head region comprises ahead eyelet extending outward from the head region and adapted to receive a fishing line; a lip extending from the head region, the lip having a surface; and a lip eyelet extending from the surface of the lip, wherein the lip eyelet, is adapted to receive a fishing line; and wherein the head region is attached to a hook portion.

### FIELD OF THE INVENTION

This invention relates to fishing hires. More particularly, it relates to a fishing hook assembly for attachment to an artificial or live lure that enables multiple types of movement through water during retrieval depending on the point of attachment of fishing line to the assembly.

### BACKGROUND OF THE INVENTION

Fishing is an ancient practice dating back to at least the Paleolithic period. The act of fishing has provided most civilizations throughout history with fish to feed human and animal inhabitants, primarily utilizing a simple device—a fishing hook. In addition to being a means for providing fish for consumption, fishing can he for recreational purposes. Recreational fishing has grown in such popularity that entire stores have evolved that market countless numbers of fishing hooks and lures.

Generally, a recreational fisherman carries tackle boxes full of various shapes and sizes of hooks and lures when out on the water fishing. Each lure provides a unique motion when retrieved in the water column, which is thought to help in enticing fish to bite the lure since the movements can sometimes “trick” a fish into thinking the lure is an actual food item naturally found in the waters. It is not uncommon for a fisherman to try numerous litres and retrieval speeds and motions in search of the perfect combination that triggers more numerous and consistent bites from targeted fish. Such tactics usually require both patience and a willingness to carry around many lures in one's tackle box.

### BRIEF SUMMARY OF THE INVENTION

The present invention enables a fisherman to utilize a single hook assembly to provide multiple patterns of lure retrieval and ease of lure interchangeability. The present invention provides the benefit, of reducing the number of hooks and lures that one must carry in their tackle box, while advantageously providing the fisherman with a simplified means to utilize numerous retrieval speeds, hire movement/motion, and lure combinations.

In one aspect, the present invention provides a fishing hook assembly for attachment to a fishing line for movement through water. The assembly comprises a head region, wherein the head region comprises a head eyelet extending outward from the head region and adapted to receive a fishing line; a lip extending from the head region, the lip having a surface; and a lip eyelet extending from the surface of the lip, wherein the lip eyelet is adapted to receive a fishing line; and wherein the head region is attached to a hook portion. Either the lip eyelet or the head eyelet can provide a point of attachment for fishing line.

In some embodiments, a hook portion comprises a first end, an elongate shaft, a curved portion, and a second end, wherein the first end is attached to the head region proximal to the head eyelet, wherein the second end comprises a point, wherein the elongate shaft and the curved portion are disposed between the first end and the second end. The second end can also comprise a first barb proximal to the point. The elongate shaft and the curved portion extend outward from the head region opposite the lip. In some embodiments, the lip extends from the head region at an angle relative to an axis running lengthwise along the elongate shaft of the hook portion. The first end of the hook portion can further comprise one or more second barb proximal to the head region. In one embodiment, the first end of the hook portion further comprises a stabilizing extension that extends integrally into the head region and the lip. Furthermore, the first end of the hook portion can be adapted to form both the head eyelet and the stabilizing extension that extends integrally into the head region and the lip.

In some embodiments, a bait keeper assembly is attached to the head eyelet. The attachment of the bait keeper can be a removable attachment. In further embodiments, a ring cars be attached to the lip eyelet, the ring being permanently or, alternatively, removably attached to the lip eyelet.

In some embodiments, the head eyelet and the lip eyelet are configured such that they are positioned along the same longitudinal axis.

This Summary is provided to introduce a selection of concepts in a simplified form that are further described below in the Detailed Description. This Summary is not intended to identity key features or essential features of the claimed subject matter, nor is it intended to be used to limit the scope of the claimed subject matter.

### BRIEF DESCRIPTION OF THE DRAWINGS

FIG. 1 shows a perspective view of a fishing hook assembly of an embodiment of the present invention for attachment to a fishing line for movement through water.

FIG. 2 shows atop view of the fishing hook assembly of FIG. 1.

FIG. 3 shows a bottom view of the fishing hook assembly of FIG. 1.

FIG. 4 shows a side view of the fishing hook assembly of FIG. 1.

FIG. 5 shows a front, top view of the fishing hook assembly of FIG. 1.

FIG. 6 shows a front bottom view of the fishing hook assembly of FIG. 3.

FIG. 7 shows a perspective view of a fishing hook assembly of an embodiment of the present invention for attachment to a fishing line for movement through water.

FIG. 8 shows a side view of the fishing hook assembly of FIG. 7.

FIG. 9 shows a side view of a fishing hook assembly of an embodiment of the present invention with a lure attached.

FIG. 10 shows a side view of a fishing hook assembly of an embodiment of the present invention with a lure attached.

FIGS. 11A and 11B show a fishing hook assembly of an embodiment of the present invention as it is attached to a fishing line for retrieval through water in a (A) diving motion and a (B) straight motion.

### DETAILED DISCLOSURE OF THE INVENTION

Aspects of the present invention provide, a fishing hook assembly for attachment to an artificial fishing lure or live bait (e.g., minnow) and fishing line for movement through water. The present invention enables a fisherman to utilize a single hook assembly to provide multiple patterns of lure retrieval and ease of lure interchangeability.

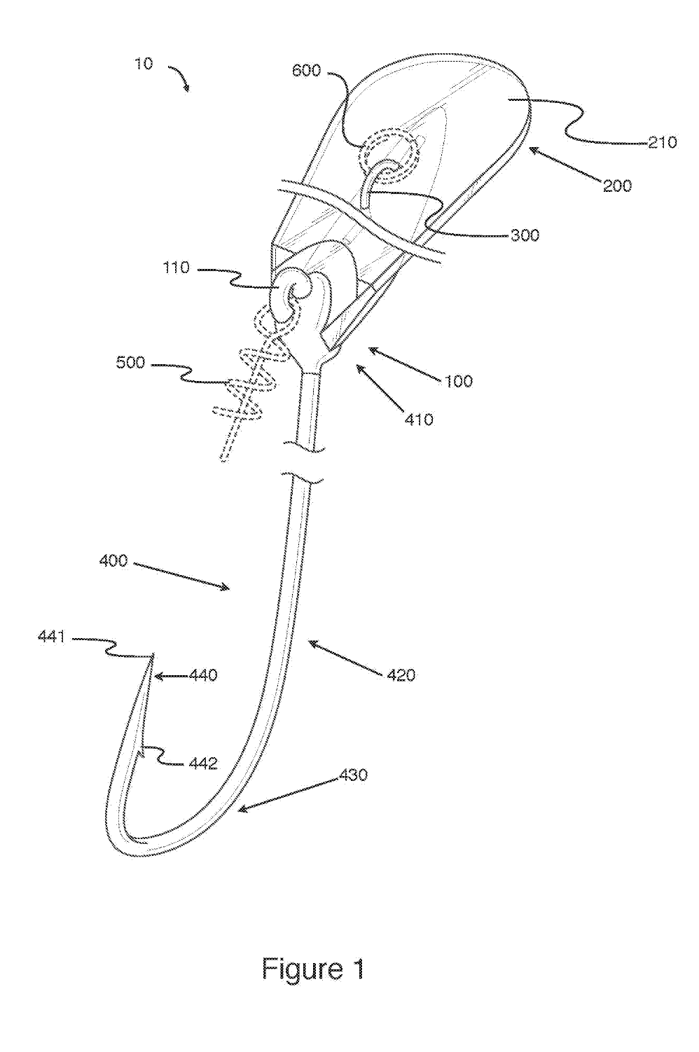

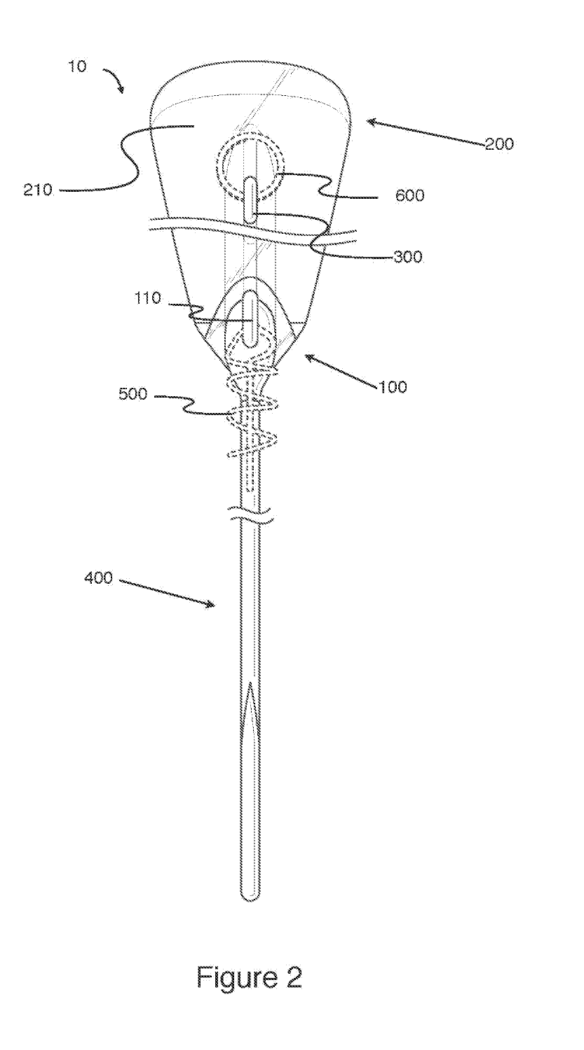

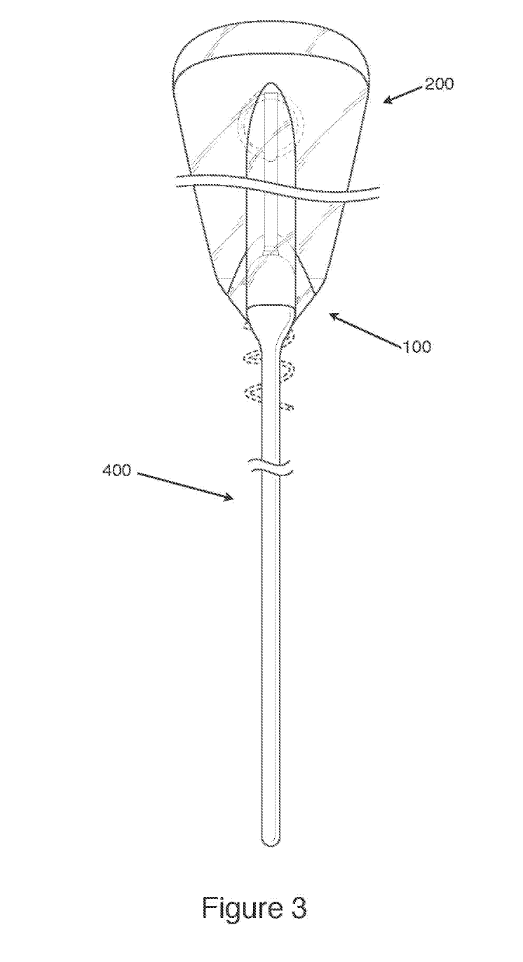

FIGS. 1-4 show a fishing hook assembly of an embodiment of the present invention. The assembly 10 comprises a head region 100 with a head eyelet 110, a lip 200, and a lip eyelet 300; the head region 100 is attached to a hook portion 400. The head eyelet 110 extends outward from the head region 100 and is adapted to receive a fishing line, which can be tied thereon. The lip 200 has a surface 210 and the lip eyelet 300 extends from this surface 210. The lip eyelet 300 provides an additional, alternative position adapted to receive a fishing line for tying thereon.

In some embodiments, the head region 100 comprises weighted material (e.g., metal or composite material) to provide weight to the hook assembly 10 to provide for faster falling of the book assembly/hire in the water column. The weighted material can also be formed into a “head” shape to mimic the heads of living bait.

In some embodiments, the lip 200 of the hook assembly 10 has a rounded end (as shown in FIG. 1). In alternative embodiments, the lip has a squared end. As would be understood in the art, the lip can be various lengths. The length of the lip is a factor affecting: the diving characteristics and movement patterns of the assembly.

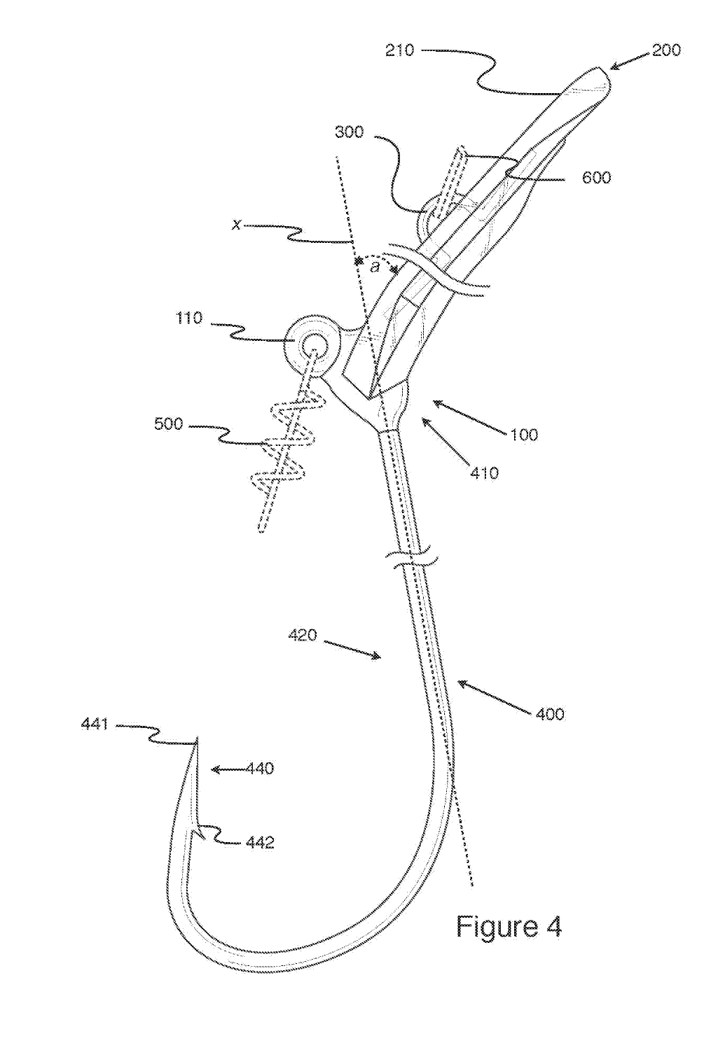

In some embodiments, as shown in FIGS. 1-4, the hook portion 400 comprises a first end 410, an-elongate shaft 420, a-curved portion 430, and a second end 440. The first end 410 of the hook portion 400 is attached to the head region 100 proximally to the head eyelet 110, and the second end 440 comprises a point 441. The elongate shaft 420 and the curved portion 430 are disposed between the first end 410 and the second end-440. The second end 440 can additionally include one or more first barb 442 proximal to the point 441 such that the hook portion 400 effectively “hooks” a fish that bites the hook assembly 10. The elongate shaft 420 and the curved, portion 430 of the hook portion 400 can extend outward from the head region 100 opposite the lip: 200. As illustrated in FIG. 4, the lip 200 can extend from the head region 100 at various angles (a) relative to an axis (x) running lengthwise along the elongate shaft 420 of the hook portion 400. As would be understood by those skilled in the art, the angle (a) can be increased with-a resultant increase in the diving action of the assembly 10 when retrieved through water via a fishing line. Likewise, a decreased angle (a) causes a resultant decrease in the diving action of the assembly 10 when retrieved through water via a fishing line. As such, an angle (a) relative to the axis (x) running lengthwise along the elongate shaft 420 of the hook portion 400 can range from about 0 degrees to about 90 degrees. Also, the assembly is designed to sink unless a floating lure is attached thereto; however, when retrieved, the assembly will retrieve (i.e., move in a swimming motion) at a depth in the water column that is dependent on various factors in addition to the angle (a) of the lip 200.

One factor that affects retrieval depth is the size of the hook portion 400. The metal wire that forms the hook portion 400 increases in weight as the size of the hook portion increases, affecting the running depth accordingly. As such, various combinations of lip sizes and angles may be utilized with varying sizes of hook portions to achieve a resultant desired retrieval depth for the various, sizes of the overall assembly. Embodiments of the assembly 10 comprise various, hook, portion 400 wire gauges, elongate shaft 420 lengths, and curved portion 430 curvature shapes, as would be understood in the art.

Another factor that affects running depth includes the size of the lip 200. As would be understood in the art, the length and/or width of the lip 200 will affect the running depth during retrieval. Embodiments of the assembly 10 comprise various lip 200 lengths and widths.

Another factor that affects running depth includes the diameter of the fishing line-attached to the assembly 10. The greater the diameter of the fishing line (i.e., the greater the pound test of the line), the shallower the running depth of the assembly during retrieval due to the increased drag from the surface contact between the fishing line and water.

The type of fishing line also affects the running depth of the assembly during retrieval Each type of fishing line, whether it is monofilament, fluorocarbon, or braid, can have its own effects on running depths. Monofilament line floats, fluorocarbon sinks, and braid has a slow sink. Monofilament will prevent the assembly from running to the desired depths due to the floating composition creating more lift and drag. Fluorocarbon sinks, which in turn helps accomplish, the desired running depth of the assembly. The composition and density of fluorocarbon sinks at a much faster rate and aids in resisting line drag through the water column.

Water temperature also affects the running depth of the assembly. The colder the water, the denser it becomes. The warmer the water, the less dense it becomes. Cold water density levels are higher, creating less mobility and freedom of movement along with more drag. This, in turn, hinders the assembly's ability to accomplish a desired running depth. As would be understood in the art, the reverse phenomena occur in warmer water.

In some embodiments, the hook portion is integrally attached to the head region at the first end proximal to the head eyelet such that the head eyelet extends outward from the head region.

In some embodiments, a ring 600 is attached to the lip eyelet 300 and can be either permanently or removably attached to the lip eyelet 300. In some embodiments, the ring 600 is in the form of a split ring, as illustrated in FIG. 1. The ring 600 provides an attachment point for fishing line such that the fishing hook assembly 10 has freedom of movement where the ring 600 attaches to the lip eyelet 300. This gives a lure that is attached to the hook assembly 10 more freedom of movement from side-to-side or up-and-down as it is retrieved through the water column—providing possible “life-like” movement to emulate the natural movements of the lure's live counterpart.

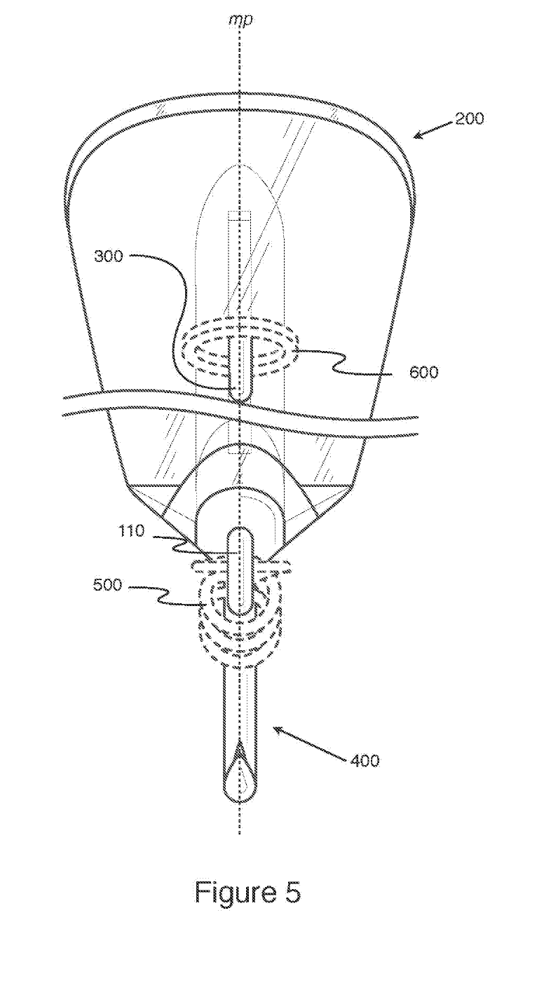

In some embodiments, the head eyelet 110 and the lip eyelet 300 are configured such that they are positioned along the same median (longitudinal) plane (mp), as shown in FIG. 5. The hook portion 400 can also be positioned along the same median (longitudinal) plane (mp).

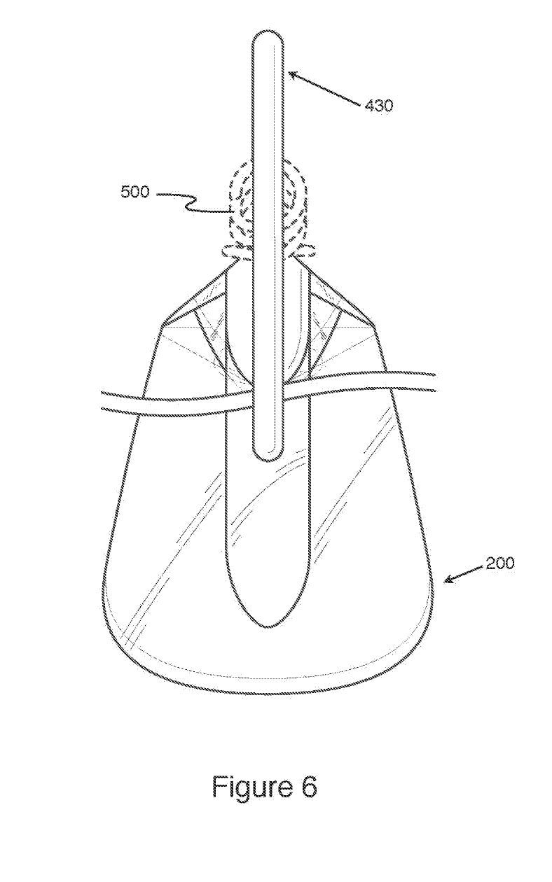

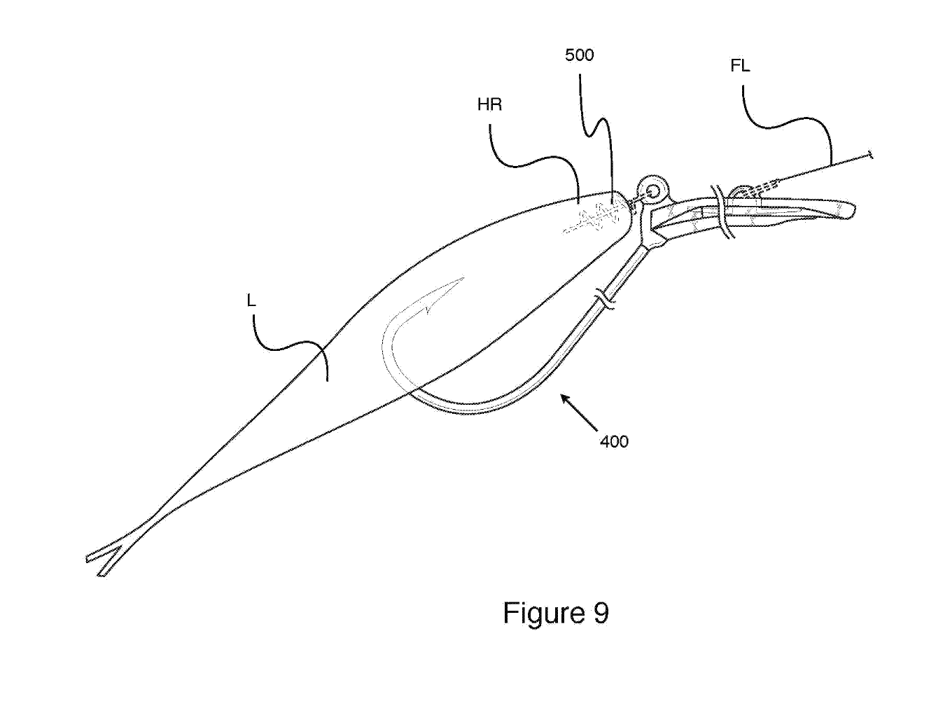

As illustrated in FIGS. 1-6, embodiments of the assembly 10 can comprise a bait, keeper assembly 500 attached to the head eyelet 110. For example, the bait keeper assembly 500 can be a wire shaped into a spiral form. A lure (e.g., a soft plastic lure) would engage the bait keeper assembly 500 and be twisted such that the end of the lure is threaded onto the bait keeper assembly 500 to ensure that the lure remains engaged with the hook assembly 10. The bait keeper assembly 500 can be either permanently or removably attached to the head eyelet 110. FIG. 9 illustrates a lure (L) that is engaged with a bait keeper assembly 500 at the lure's head region (HR) and further engaged with the hook portion 400 in the lure's body region. Furthermore, the hook assembly embodiment illustrated in FIG. 9 shows fishing line (FL) as it would attach to the ring 600 that is attached to the lip eyelet 300.

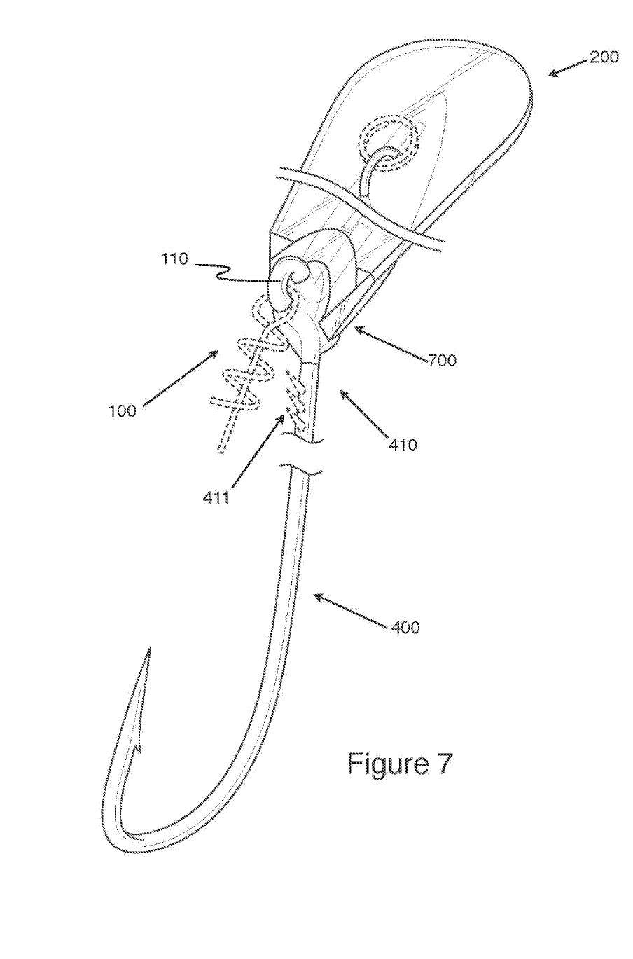

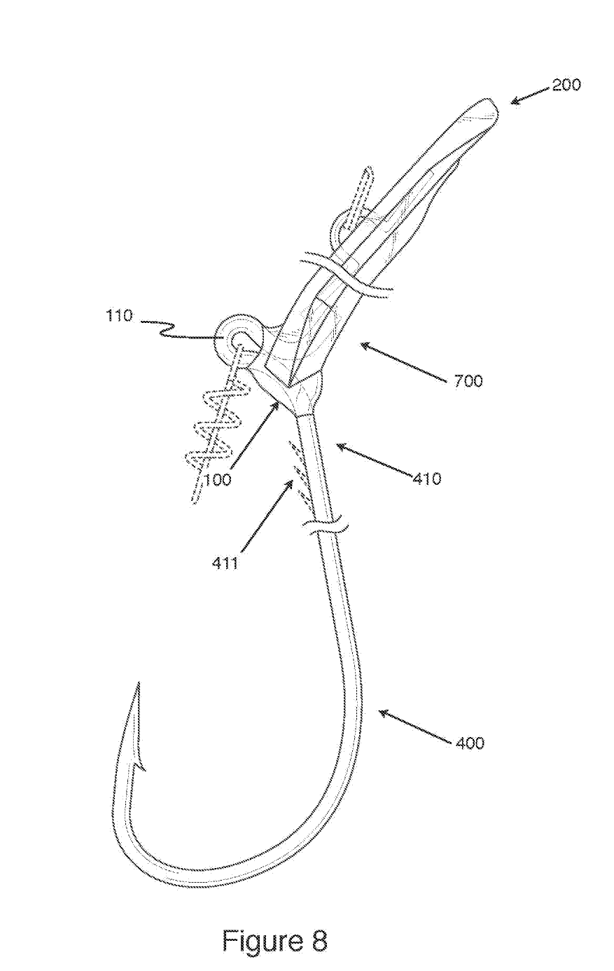

As illustrated in FIGS. 7-8, the first end of the hook portion 400 in some embodiments can further comprise one or more second barb 411 proximal to the head region. The one or more second barb 411 can provide a point of engagement with an artificial or live hire when it is threaded onto the elongate shaft 420 of the hook portion 400 such that the lure remains in position on the hook portion 400 during use. In some embodiments, the one or more second barb 411 provides the same benefit of “holding” the bait, (i.e., artificial or live lure) in the proper position on the hook portion 400 as a bait keeper assembly 500; as such, a bait keeper assembly 500 may not be attached to the head eyelet 110 when the hook portion 400 comprises one or more second barb 411. In alternative embodiments, the first end of the hook portion 400 can comprise a bait keeper formed as a plastic, composite, or carbon fiber sheath around the elongate shaft 420 of the hook portion 400 proximal to the head region (as opposed to the one or more second barb 411). This form of bait keeper also includes a barb formation extending therefrom to help “hold” the bait in place.

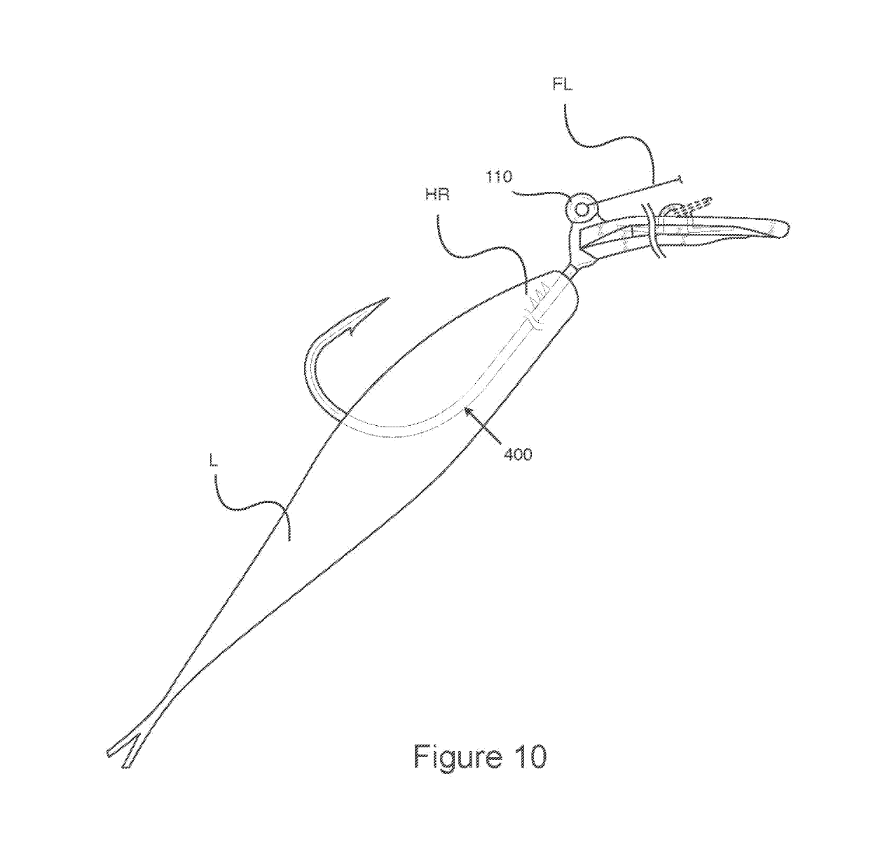

FIG. 10 illustrates a lure (L) that is engaged with a hook portion 400 such that one or more second basil 411 secures the lure (L) at the lure's head region (HR) and the hook portion 400 extends through the lure's body region and then exits the lure. Furthermore, the embodiment of the hook assembly 10 illustrated in FIG. 10 shows fishing line (FL) as it would attach to the head eyelet 110.

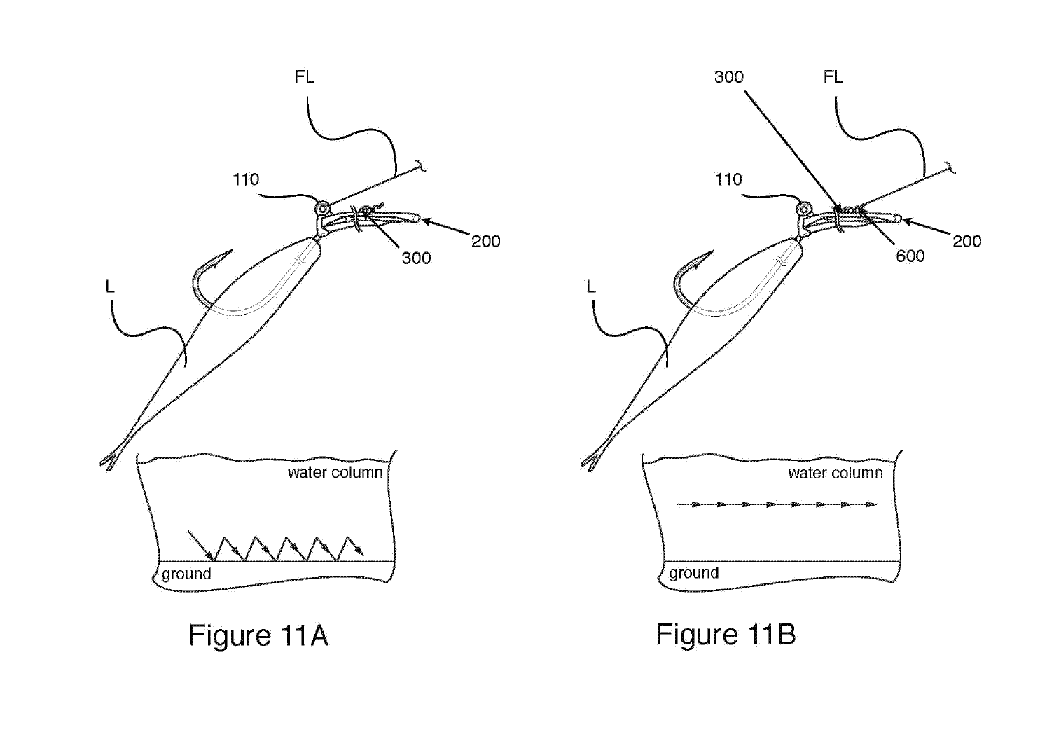

Embodiments of the hook assembly provide a fisherman with the ability to obtain multiple movements in the water column from a lure attached thereto depending on where the fishing line attaches to the hook assembly (in addition to the factors that affect retrieval depth as previously described herein). For instance, FIG. 11A illustrates the movement of a lure (L) attached to a hook assembly 10 of the present invention when the fishing line (FL) is attached at the head eyelet 110. FIG. 11B illustrates the movement of the same lure attached to the same hook assembly 10 of the present invention when the fishing line (FL) is attached at the lip eyelet 300 (optionally, the fishing line (FL) can be attached via the ring 600 that is attached to the lip eyelet 300, as shown). Since the lip eyelet 300 is positioned farther forward of the head eyelet 110 on the lip 200, the hp 200 does not point downward to the same degree during retrieval when the fishing line (FL) is attached at the lip eyelet 300 (see FIG. 11B) versus when attached at the head eyelet 110. As a result, the movement of the lure in FIG. 11B in the water column during retrieval shows a relative straight pattern of movement towards the source of retrieval (i.e., a fisherman's fishing reel) (see bottom panel, FIG. 11B). Alternatively, the movement of the lure in FIG. 11A in the water column during retrieval shows a diving pattern of movement (downward) in the water column such that the lure tends to strike the ground and bounce off of the ground continually during retrieval (see bottom panel, FIG. 11A). This diving motion occurs due to the fishing line (FL) being attached at the head eyelet 110, which allows for the lip 200 to be pushed downwards from the water resistance as the forward motion occurs during retrieval, wherein the water resistance pushes against the lip 200 and causes the lure to “dive” downwards. As such, multiple, distinct movements can be obtained from a single embodiment of the hook assembly 10 based on the point of attachment of the fishing line on the assembly (head eyelet 110 versus lip eyelet 300 (or ring 600 attached thereto)).

In another aspect, the first end 410 of the hook portion 400 farther comprises a stabilizing extension 700 that extends integrally into the head region 100 and the lip 200. As shown in FIGS. 7 and 8, the stabilizing extension 700 can be adapted as an extension of the hook portion 400 that further forms the head eyelet 110 and further extends integrally into the lip 200, The stabilizing extension 700 provides additional strength and stability to the hook assembly 10 and helps to ensure the lip 200, head eyelet 110, and hook portion 400 remain in proper alignment. In alternative embodiments, the stabilizing extension does not form the head eyelet and extends from the hook portion 400 directly into the lip 200.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

All patents, patent applications, provisional applications, and publications referred to or cited herein are incorporated by reference in their entirety, including all figures and tables, to the extent they are not inconsistent with the explicit teachings of this specification.

It should be understood that, the examples and embodiments described herein are for illustrative purposes only and that various modifications or changes in light thereof will be suggested to persons skilled in the art and are to be included within the spirit and purview of this application and the scope of the appended claims.

We claim:

1. A fishing hook assembly for attachment to a fishing line for movement through water, comprising:
a head region, wherein the head region comprises a head eyelet extending outward from the head region and adapted to receive a fishing line;
a lip extending from the head region, the lip having a surface;
a lip eyelet extending from the surface of the lip, wherein the lip eyelet is adapted to receive a fishing line:
wherein the head region is attached to a hook portion.

2. The fishing hook assembly of claim 1, wherein the hook portion comprises a first end, an elongate shaft, a curved portion, and a second end, wherein the first, end is attached to the head region, wherein the second end comprises a point, wherein the elongate shaft and the curved portion are disposed between the first end and the second end.

3. The fishing hook assembly of claim 2, wherein the second end comprises a first barb proximal to the point.

4. The fishing hook assembly of claim 2, wherein the elongate shaft and the curved portion extend outward from the head region opposite the lip.

5. The fishing hook assembly of claim 2, wherein the lip extends from the head region at an angle relative to an axis running lengthwise along the elongate shaft of the hook portion.

6. The fishing hook assembly of claim 2, wherein the first end of the hook portion further comprises one or more second barb proximal to the head region.

7. The fishing hook assembly of claim 1, wherein a bait keeper assembly is attached to the head eyelet.

8. The fishing hook assembly of claim 7, wherein the bait keeper assembly is removably attached to the head eyelet.

9. The fishing hook assembly of claim 1, further comprising a ring attached to the lip eyelet.

10. The fishing hook assembly of claim 9, wherein the ring is removably attached to the lip eyelet.

11. The fishing hook assembly of claim 2, wherein the first end of the hook portion further comprises a stabilizing extension that extends integrally into the head region and the lip.

12. The fishing hook assembly of claim 11, wherein the first end of the hook portion is adapted to form the head eyelet and the stabilizing extension.

13. The fishing hook assembly of claim 1, wherein the head eyelet and the lip eyelet are configured such that they are positioned along the same median plane.
